(19) United States
(12) Patent Application Publication
(10) Pub. No.: US 2014/0156346 A1
(43) Pub. Date: Jun. 5, 2014

(54) METHODS AND SYSTEMS FOR DYNAMIC DEMAND SENSING

(71) Applicant: SAP AG, Walldorf (DE)

(72) Inventor: Danqing Jessie CAI, Singapore (SG)

(73) Assignee: SAP AG, Walldorf (DE)

(21) Appl. No.: 13/705,125

(22) Filed: Dec. 4, 2012

(51) Int. Cl. G06Q 30/02; G06Q 50/00

(52) U.S. Cl. CPC G06Q 30/0202; G06Q 50/01
USPC 705/7.31

(57) ABSTRACT

Described herein is a technology for facilitating dynamic demand sensing. In some implementations, demand sensing data is received from a consumer device. The demand sensing data is generated while the consumer device is in-store. An information management system is updated with the demand sensing data. Analytics may then be performed on the demand sensing data to generate a demand report displayed at the information management system.

### TECHNICAL FIELD

The present disclosure relates generally to dynamic demand sensing.

### BACKGROUND

Retail businesses and their upstream suppliers and wholesalers are always in need of data to support and affirm their decision-making in product design, procurement, sales, logistics, and other business functions. However, the right kind of data is not easy to obtain. Presently, the time required for businesses to sense demand is, on the average, at least three times the time required to process an order. The difficulties in meeting and keeping up with the demands of the consumers and fulfilling the consumers' orders represent friction in retail transactions that can be quite costly to businesses in the supply chain (e.g., suppliers, wholesalers, distributors, retailers).

There are two major problems with traditional demand sensing data: forecast inaccuracy and untimeliness. For example, historical point-of-sale (POS) data is typically employed to provide an indication of demand, because it is commonly perceived as accurate. However, such data may actually be misleading, since what consumers bought today does not necessarily lead to more future sales. This may be due to, for instance, untold dissatisfaction with the purchased goods at many levels, including price, product quality, specific design, service level, and so forth.

Other types of data, such as market research reports and statistics derived from professionally designed market surveys, do not provide a timely indication of demand as it takes a considerable amount of time to compile and summarize such data. It is often not realistic or efficient for routine business operations (e.g., procurement planning) to incorporate such market research results in decision-making.

Thus, a need exists for systems, methods, and apparatuses to address the shortfalls of current technology, and to provide other new and innovative features.

### SUMMARY

A computer-implemented technology for facilitating dynamic demand sensing is described herein. In some implementations, demand sensing data is received from a consumer device. The demand sensing data is generated while the consumer device is in-store. An information management system is updated with the demand sensing data. Analytics may then be performed on the demand sensing data to generate a demand report displayed at the information management system.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 is a block diagram illustrating an exemplary system;

FIG. 2 shows an exemplary method of dynamic demand sensing;

FIG. 3 shows a screenshot of an exemplary mobile application;

FIG. 4 shows a screenshot of an exemplary retailer IMS;

FIG. 5 shows another screenshot of an exemplary retailer IMS; and

FIG. 6 shows a screenshot of an exemplary supplier IMS.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

Systems, methods, and apparatuses for facilitating dynamic demand sensing are described herein. In one aspect of the present framework, social network data generated in an actual store environment is used for demand sensing. The demand sensing provided by the present framework can be both accountable and substantially in real-time. This advantageously allows businesses to enhance the level of supply chain transparency and agility. Instead of the traditional product “push” from manufacturers and wholesalers, consumers may request and “pull” the products they demand for their needs. Moreover, researchers may use the present framework as a basis to study how exactly social behaviors, such as agreeing/disagreeing or sentiments expressed in detailed comments, make an impact on actual sales of products.

Unlike conventional techniques that locate the target market by examining on-line transactions or physical transactions independent of store information, implementations of the present framework connect in-store customers electronically and link them directly to the store's information management system. Thus, well-structured consumer defined content may be included in the business planning cycle (e.g., procurement and promotion planning), and in-store customer experience may be brought to the next level. These, and other exemplary features, will be discussed in more details in the following sections.

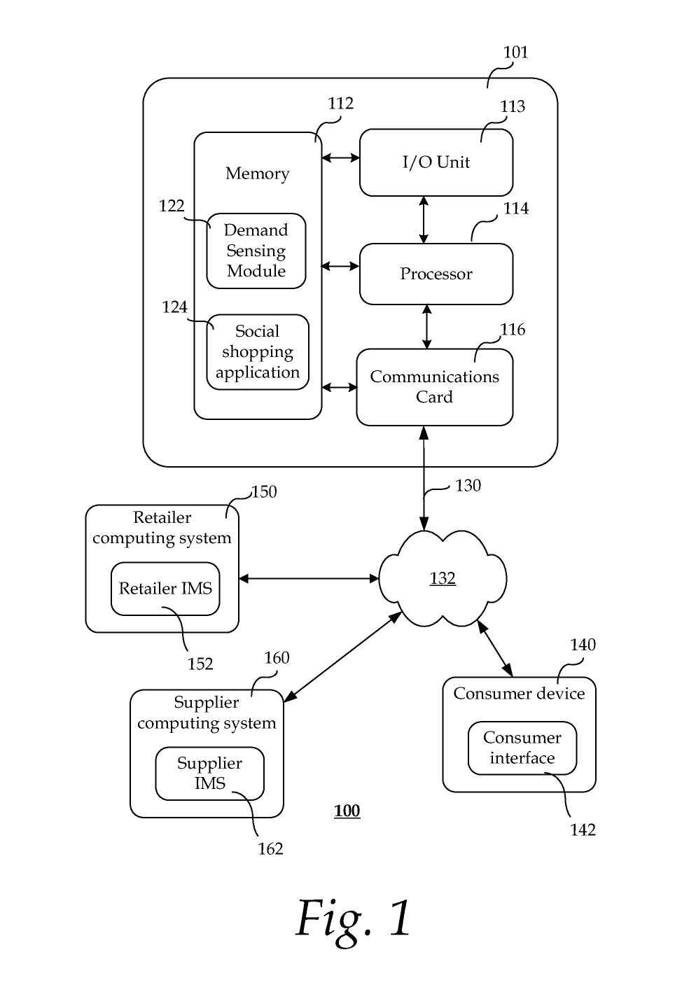

FIG. 1 is a block diagram illustrating an exemplary system 100 that implements the framework described herein. The system 100 generally includes a server 101, a consumer device 140, a retailer computing system 150, a supplier computing system 160, at least some of which are communicatively coupled through a network 132. Although shown as a single machine, the server 101 may include more than one server, such as a server pool. Two or more consumer devices 140, retailer computing systems 150 and/or supplier computing systems 160 may also operate in the system 100. The server 101 may be implemented from a website or cloud, and deliver content to one or more applications.

Turning to the server 101 in more detail, it may include a non-transitory computer-readable media or memory 112, a processor 114, an input-output unit 113, and a communications card 116. Non-transitory computer-readable media or memory 112 may store machine-executable instructions, data, and various programs, such as an operating system (not shown), web services, a demand sensing module 122 for implementing the techniques described herein, a social shopping application 124, all of which may be executable by processor 114. As such, the server 101 is a general-purpose computer system that becomes a specific purpose computer system when executing the machine-executable instructions. Alternatively, the demand sensing module 122 described herein may be implemented as part of a software product or application, which is executed via the operating system. The application may be integrated into an existing software application, such as an add-on or plug-in to an existing application, or as a separate application. The existing software application may be a suite of software applications. It should be noted that the demand sensing module 122 may be hosted in whole or in part by different computer systems in some implementations. Thus, the techniques described herein may occur locally on the server 101, or may occur in other computer systems and be reported to server 101.

Each computer program may be implemented in a high-level procedural or object-oriented programming language, or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

Generally, memory 112 may include any memory or database module for storing data and program instructions. Memory 112 may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 101.

In some instances, memory 112 can function as an in-memory database to allow seamless access to and propagation of high volumes of data in real-time. Parallel processing may further be achieved by using a multicore processor 114 in conjunction with the in-memory database. The in-memory database is a database management system that relies primarily on a system's main memory for efficient computer data storage. More particularly, the data in the in-memory database resides in volatile memory and is not persistently stored on a hard drive, thereby allowing the data to be instantly accessed and scanned at a speed of several megabytes per millisecond.

Column-based data storage may further be implemented in the in-memory database, where data tables are stored as columns of data, in sequence and in compressed memory blocks. This may facilitate faster aggregation of data when calculations are performed on single columns. Alternatively, row-based data storage is also possible. In some implementations, instead of updating entire rows, only fields that have changed will be updated. This avoids having to lock entire data tables during updates to prevent conflicting modifications to a set of data. High levels of parallelization may be achieved, which is critical to real-time processing of live data streams and performing constant and substantially simultaneous updates.

In some implementations, server 101 is communicatively coupled to an input device (e.g., keyboard, touch screen or mouse) and a display device (e.g., monitor or screen) via the I/O unit 113. In addition, server 101 may also include other devices such as a communications card or device (e.g., a modem and/or a network adapter) for exchanging data with a network using a communications link 130 (e.g., a telephone line, a wireless network link, a wired network link, or a cable network), and other support circuits (e.g., a cache, power supply, clock circuits, communications bus, etc.). In addition, any of the foregoing may be supplemented by, or incorporated in, application-specific integrated circuits.

Server 101 may operate in a networked environment using logical connections to one or more consumer devices 140, retailer computing systems 150, supplier computing systems 160 over one or more intermediate networks 132. These networks 132 generally represent any protocols, adapters, components, and other general infrastructure associated with wired and/or wireless communications networks. Such networks 132 may be global, regional, local, and/or personal in scope and nature, as appropriate in different implementations. The network 132 may be all or a portion of an enterprise or secured network, while in another instance, at least a portion of the network 132 may represent a connection to the Internet. In some instances, a portion of the network may be a virtual private network (VPN). The network 132 may communicate, for example, Internet Protocol (IP) packets, Frame Relay frames, Asynchronous Transfer Mode (ATM) cells, voice, video, data, and other suitable information between network addresses. The network 132 may also include one or more local area networks (LANs), radio access networks (RANs), metropolitan area networks (MANs), wide area networks (WANs), all or a portion of the World Wide Web (Internet), and/or any other communication system or systems at one or more locations.

In general, consumer device 140 may be any computing device operable to connect to or communicate with at least the server 101, the retailer computing system 150, the supplier computing system 160 and/or the network 132 using a wired or wireless connection. In some implementations, the consumer device 140 is a mobile device that can be used by an end-user to communicate information using radio technology. The consumer device 140 may be a cellular phone, personal data assistant (PDA), smartphone, laptop, tablet personal computer (PC), e-reader, media player, a digital camera, a video camera, Session Initiation Protocol (SIP) phone, touch screen terminal, enhanced general packet radio service (EGPRS) mobile phone, navigation device, an email device, a game console, any other suitable wireless communication device capable of performing a plurality of tasks including communicating information using a radio technology, or a combination of any two or more of these devices.

The consumer device 140 may include an input device, a display, a processor, a memory or non-transitory computer-readable media, an interface card, and so forth. In some implementations, the memory stores a consumer interface 142. The consumer interface 142 may be, for example, a mobile application. The consumer interface 142 may be written in any programming language, such as a C, C++, Java, Visual Basic, assembler, Perl, any suitable version of 4GL, as well as others.

Consumers may, for example, interact with the consumer interface 142 to subscribe or otherwise procure rights to one or more services provided by server 101. Services include, for example, streaming of offers, product feeds, recommendations, etc. For instance, the consumers may interact with the consumer interface 142 by specifying their email address, mobile device phone number and/or other contact information. The consumer interface 142 may provide additional functions, such as a product catalogue for consumers to browse, check prices of scanned products, maintain shopping lists, collaborate with others during shopping, etc. Even further, the consumer interface 142 may allow the user to access social networking services provided by the social shopping application 124. For example, consumers may rate, review and/or comment on products, interact with other shoppers, etc. These and other features will be described in more detail later.

The retailer computing system 150 and the supplier computing system 160 may be any electronic computer devices operable to receive, transmit, process, and store any appropriate data associated with the system 100 of FIG. 1. Although shown as single machines, the retailer computing system 150 and the supplier computing system 160 may be embodied as multiple machines. The retailer computing system 150 and the supplier computing system 160 may each be, for example, a personal computer, a desktop, a laptop, a touch screen terminal, a workstation, a network computer, a server, etc. One or more processors within these or other devices, or any other suitable processing device, and typically includes many or all of the elements described above relative to server 101. The retailer computing system 150 and the supplier computing system 160 may also include one or more instances of non-transitory computer readable storage media or memory devices (not shown).

The memory of the retailer computing system 150 may include a retailer information management system (IMS) 152 suitable for interacting with the demand sensing module 122 over the network 132. The memory of the supplier computing system 160 may also include a supplier information management system (IMS) 162 suitable for interacting with the demand sensing module 122 over the network 132. In some implementations, the retailer and supplier IMS (152 and 162) are written in any programming language that enables them to interact with a web browser, such as a C, C++, Java, Visual Basic, assembler, Perl, any suitable version of 4GL, as well as others.

Generally, the retailer IMS 152 serves to facilitate the processing and/or display of information related to products sold or offered for sale at one or more physical locations (e.g., brick-and-mortar retail store). For example, the retailer IMS 152 may provide sales, pricing, quantities, availability, source, shelf location, store layout and/or other information about the products sold or offered for sale in a supermarket. The retailer IMS 152 may also provide information related to the consumers of the products, such as the location of customers on the retail store floor, comments, likes/dislikes and other feedback and/or social networking information from the customers, and so forth. Further, the retailer IMS 152 may also provide customized reports based on such information. These and other exemplary features will be described in more detail in the following sections.

In some implementations, the supplier IMS 162 serves to facilitate the processing and/or display of information related to products supplied or to be supplied to a retailer by a manufacturer, vendor, wholesaler, distributor, importer, exporter, or any other type of supplier. For example, the supplier IMS 162 may provide information related to the sales, availability, quantities, pricing, location in the warehouse, shipping dates, status and/or tracking information, or other information of each product. Further, the supplier IMS 162 may also provide information related to the consumers of the products, such as comments, likes/dislikes and other feedback and/or social networking information from the customers, and so forth. Even further, the supplier IMS 162 may also provide customized reports based on such information. These and other exemplary features will be described in more detail in the following sections.

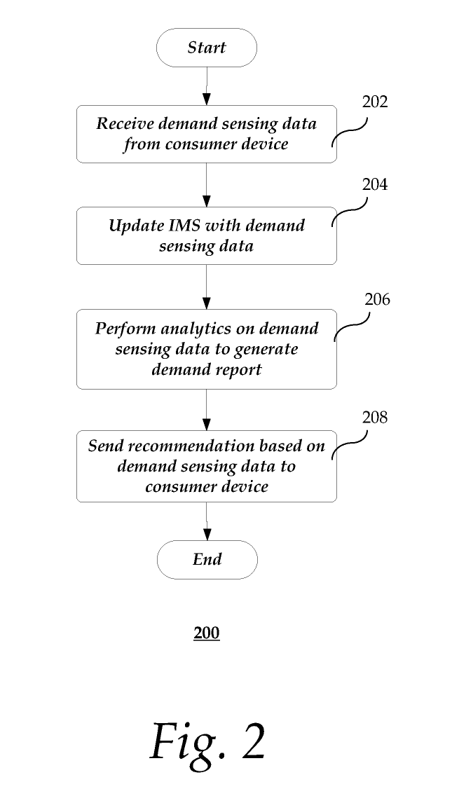

FIG. 2 shows an exemplary method 200 of dynamic demand sensing. The method 200 may be implemented by the system 100, as previously described with reference to FIG. 1. It should be noted that in the following discussion, reference will be made, using like numerals, to the features described in FIG. 1.

At 202, the demand sensing module 122 receives demand sensing data. In some implementations, the demand sensing module 122 collects the demand sensing data from an in-store consumer device 140 (i.e. while the customer is physically in the brick-and-mortar store). The demand sensing data may be stored in an in-memory database 112 for subsequent retrieval and real-time processing. Demand sensing data may be explicitly entered by, for instance, an in-store customer via the consumer interface 142 of the consumer device 140. Alternatively, the consumer device 140 may automatically send data to the server 101 while the customer is in the store.

Demand sensing data generally refers to any information that is indicative of a consumer's desire and willingness to pay a price for a specific good or service. Such data may be generated while the consumer device is in-store, and may include user data, temporal data, spatial data, transactional data, non-transactional data, social network data, or a combination thereof.

User data may be any user-provided data that identifies the user, including contact information (e.g., telephone number, email, address, etc.), age, gender, income, and any other personal information. Spatial data refers to any data that identifies a physical location of the consumer device 140 (or user). In some implementations, the spatial data identifies a physical section of the store (e.g., shelf, aisle number, store floor, department, etc.) where the consumer device 140 (or user) is presently located. The spatial data may include any passively collected location data, such as cell tower data, global packet radio service (GPRS) data, global positioning service (GPS) data, WI-FI data, personal area network data, IP address data and data from other network access points, or actively collected location data, such as location data entered by the user. In some cases, such spatial data is combined with temporal data, such as time and/or date stamp.

Transactional data refers to any data associated with potential or actual sales transaction (or checkout) of one or more products (e.g., point-of-sale or POS data). Such data may be associated with a particular product, such as its total sales volume, historical prices, payment information (e.g., mode of payment), location and/or time of sale, etc. It may also be associated with a particular consumer, such as his or her purchasing history, such as the category, type, brand or price range of previous purchases. Non-transactional data refers to any data that is generated in response to a “non” sales transactional event. An example of a “non” sales transactional event is a consumer picking up an item and scanning an image of the item or a portion thereof (e.g., barcode, all or a portion of the product packaging, product name, brand name, product number, etc.) using her mobile consumer device 140 to, for example, learn more information about the product. Even though such event may or may not result in an actual sales transaction, it provides valuable information to the retailer about the consumer's behavior and an opportunity to turn a missed sale into an actual sale or purchase. Non-transactional data may include, for example, the time and/or date stamp of the scanning, the scanned image, the scanned product information, the addition or removal of an item to a shopping cart, picking sequence, time elapsed since the occurrence of a previous event, and so forth.

Social network data refers to any product-related data received via a social shopping application 124 or any other social network, forum and/or blog (e.g., Facebook, LinkedIn, Twitter, Foursquare, etc.). Social network data may include, for example, comments, ratings (e.g., like or dislike), status, information about other actions within the social network, etc. Actions within the social network may include recommending or suggesting a particular product to a connected user (e.g., friend) within the user's network, sharing a link (e.g., emailing or otherwise forwarding a link of a product description), and so forth.

In some implementations, the social shopping application 124 provides consumers, retailers and suppliers the ability to communicate, collaborate and/or interact effectively within groups of related users. These features allow the users to track each other's activities and be better informed decision-makers. For example, in-store consumers may interact with other related users, retailers and/or suppliers to review, rate, or comment on particular products, engage in collaborative shopping and/or other activities. Retailers may use the social shopping application 124 to review and comment on consumer feedback and interact with other product suppliers. Suppliers may review the consumer feedback on supplied products and interact with the consumers and retailers. The social shopping application 124 provides a fully integrated platform where consumers (particularly in-store consumers), retailers and suppliers may interact directly and retail analytics are incorporated seamlessly to improve the shopping experience in a brick-and-mortar retail store.

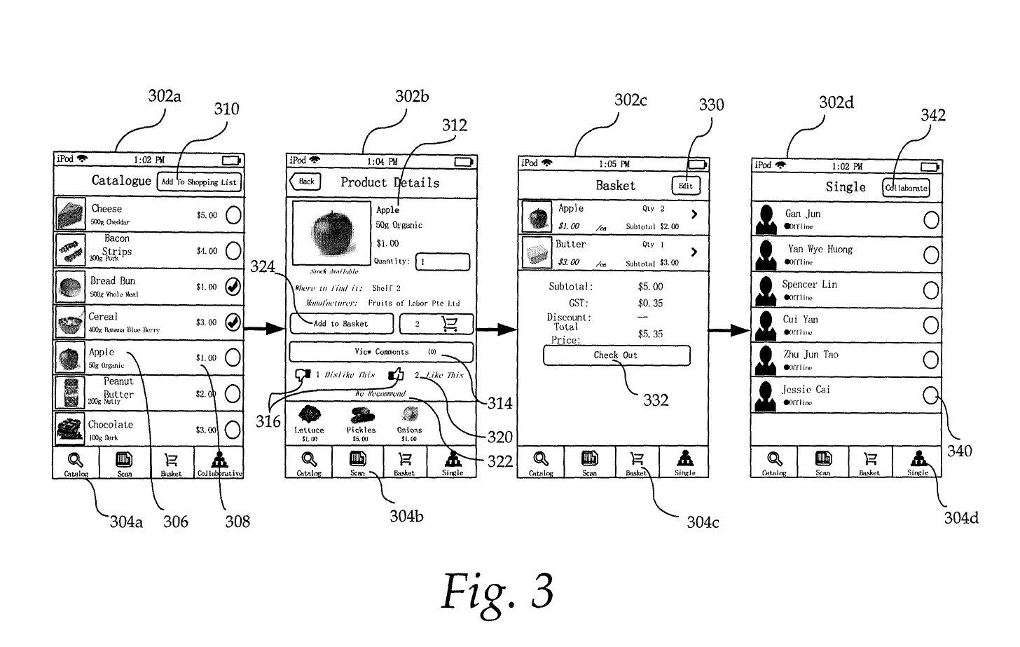

FIG. 3 shows screen shots 302a-d of an exemplary mobile application 142. The mobile application 142 may be accessed at the consumer device 140. In some implementations, the mobile application 142 interacts with the social shopping application 124 to provide social network data. The mobile application 142 may also interact with the demand sensing module 122 to provide other types of data.

When a user is in or near a physical retail store, he or she may initially log into the social shopping application 124 using any known login protocol. Typically, this includes the user providing a username and password via a logon page on the mobile application 142. After logging in, the user may select one of the page elements 304a-d to browse a product catalog, scan a product for additional details, edit a shopping basket and/or engage in collaborative shopping with other users. It should be appreciated that other features may also be provided.

If the user selects the first element 304a, a product catalog is presented. The product catalog may display a listing of products 306 and corresponding prices 308 offered in the retail store. The user may create a shopping list 310, and select, add and/or remove one or more products from the shopping list 310.

If the user selects the second element 304b, detailed information of a selected product 312 is presented. The user may select the product from the listing of products 306 in the product catalog. Alternatively, the product may be selected by scanning an image of the physical product or a portion thereof (e.g., barcode). For example, a consumer may pick up and scan a product using her mobile consumer device to learn more information about the product and decide whether or not to purchase the product.

Various types of detailed information of the selected product may be displayed. For example, the user may view the retail price, quantity, options, warranty, whether stock is available, location of the product, manufacturer details, etc. Such product information may be retrieved from the retailer IMS 152. In addition, the user may also view social network information about the selected product and interact with other users via the social shopping application 124. For example, the user may view and/or enter comments 314 from other users, rate the product (e.g., like or dislike) by selecting the respective icon 316, view the number of users 320 who liked or disliked the product, view recommendations 322 from the seller, etc. The user may then add the product and desired quantity to his or her shopping basket by selecting the respective button 324.

If the user selects the third element 304c, the shopping basket is presented. The shopping basket may display a listing of one or more products, corresponding prices, quantities desired by the user, and total price, including taxes and any discounts. The user may edit the shopping basket (e.g., add or delete products) by selecting the edit button 330. After reviewing the shopping basket, the user may check out the items by selecting the check-out button 332. The user may then pay for the items using his or her preferred mode of payment (e.g., credit card, debit card, check, coupon, gift card, PayPal, MobileMoney, etc.).

If the user selects the fourth element 304d, the user may toggle between single and social shopping through collaboration. To collaborate with others, the user may select one or more contacts or users 340 in the user's network and select the collaborate button 342. While in the social shopping mode, the user may communicate directly with the selected one or more related users to share shopping basket information.

Referring back to FIG. 2, at 204, the demand sensing module 122 updates an information management system (IMS) with the demand sensing data. The IMS may be the retailer IMS 152 and/or the supplier IMS 162. In some implementations, the demand sensing module 122 updates the IMS immediately or substantially in real-time. By linking the consumer device 140 directly to the IMSs (152 and 162) of the retailer and supplier computing systems (150 and 160) via the server 101, up-to-date content can be provided dynamically for use in the business planning cycle (e.g., procurement, promotion planning, etc.) to improve the in-store shopping experience.

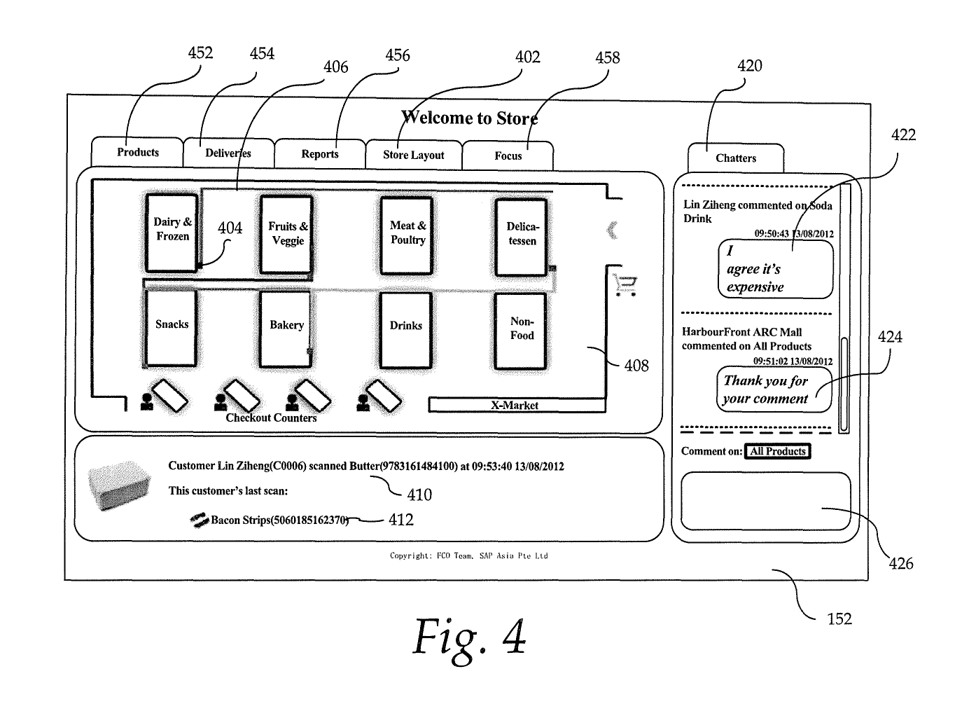

FIG. 4 shows a screenshot of an exemplary retailer IMS 152. The retailer IMS 152 may be accessed at the retailer computing system 150. As discussed previously, the retailer IMS 152 may facilitate the processing and/or display of information related to products sold or offered for sale at one or more physical locations (e.g., brick-and-mortar retail store).

The retailer IMS 152 may be updated with different types of demand sensing data. In some implementations, the retailer IMS 152 is updated with spatial data. When the user selects the “Store Layout” tab 402, a floor plan 408 of the store layout may be displayed. Based on the spatial data, the location 404 of one or more consumers (and/or consumer devices 140) may be tracked and displayed in the floor plan 408. The path 406 that each of the consumer took while in the store may also be traced. The spatial data may be combined with temporal data, such as time and/or data stamp associated with the stops made by the consumer while in-store.

In some implementations, the retailer IMS 152 is updated with non-transactional data associated with an in-store consumer. As shown, the retailer IMS 152 may display information about when (e.g., date and time) 410 an in-store consumer most recently scanned a product, which product was scanned, and when (e.g., data and time) 412 the given user last scanned another product.

In some implementations, the retailer IMS 152 is updated with social networking data associated with an in-store consumer and a retailer. As illustrated, an ongoing chatter between the retailer and a consumer may be displayed under the “Chatters” tab 420. For example, the in-store consumer may post a comment 422 about a particular product. The retailer may respond by posting a reply 424 to the comment 422. The retailer may choose to post a comment 426 on a particular product or all products in the store.

Other features may also be provided by the retailer IMS 152. For example, the retailer IMS 152 may display information (e.g., stock availability, location in warehouse, etc.) about the inventory of products when the user selects the “Products” tab 452. The retailer IMS 152 may also display information (e.g., shipping date, tracking location, carrier, shipping address, etc.) about the delivery of products when the user selects the “Deliveries” tab 454. Further, the retailer IMS 152 may display reports generated by the demand sensing module 122, when the user selects the “Reports” tab 456. More details of these reports will be provided in the subsequent discussion. Even further, when the user selects the “Focus” tab 458, the retailer IMS 152 may display real-time transactional or POS data of sold products.

Referring back to FIG. 2, at 206, the demand sensing module 122 may perform analytics on the demand sensing data to generate one or more demand reports. The demand reports may be generated in response to a request from the retailer IMS 152 and/or the supplier IMS 162.

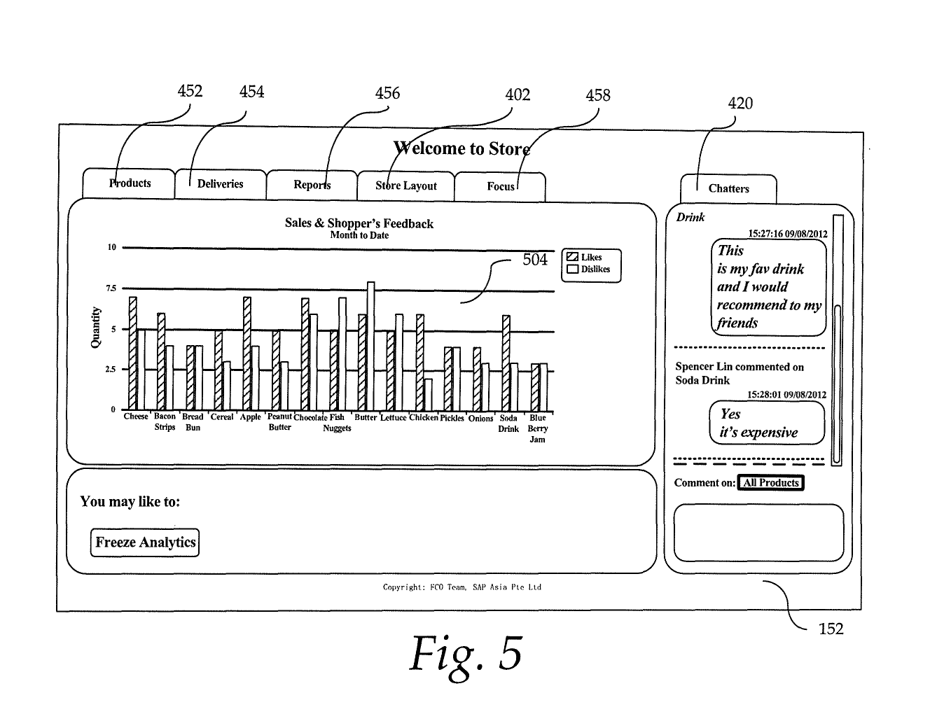

FIG. 5 shows another screenshot of an exemplary retailer IMS 152. As shown, when the user selects the “Reports” tab 456, a report 504 is displayed. The report 504 may summarize the sales and consumer feedback derived from social networking data (e.g., ratings or likes/dislikes) included in the demand sensing data. A bar graph illustrating the number of likes and dislikes for each product may be shown in the report. The report may be customized according to user's preferences. For instance, the user may specify the type of graphical chart (e.g., pie chart, bar or line graphs), the display preferences (e.g., color, contrast, etc.), the number and types of products, the time period, the type of data used, etc. Other types of demand reports are also possible.

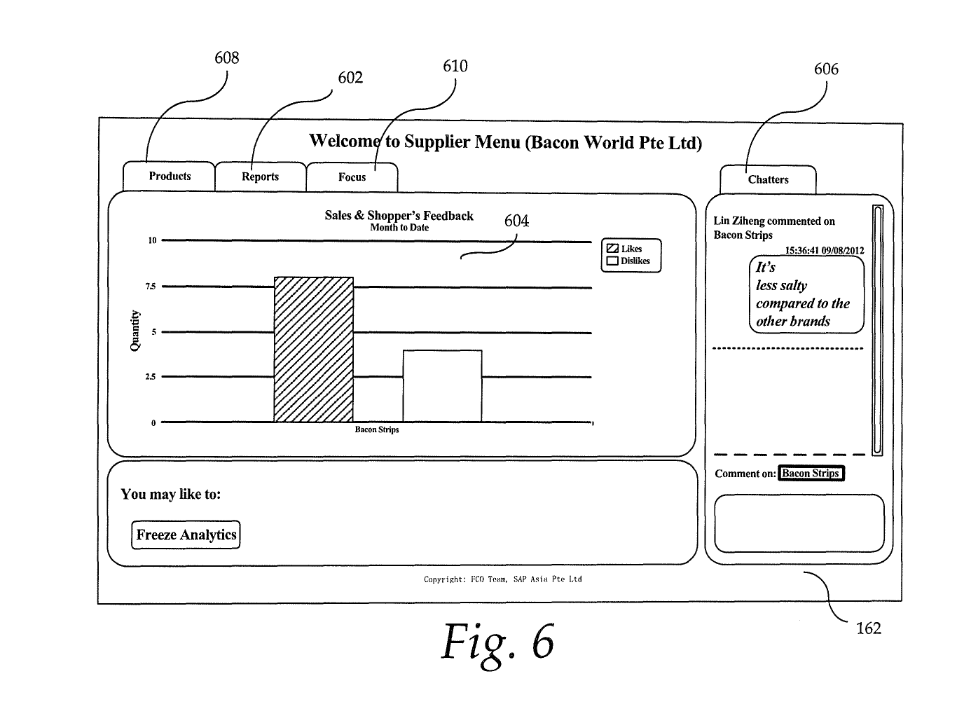

FIG. 6 shows a screenshot of an exemplary supplier IMS 162. The supplier IMS 162 may be accessed at the supplier computing system 160. As discussed previously, the supplier IMS 162 may facilitate the processing and/or display of demand sensing information and other information related to products supplied or to be supplied to a retailer by a manufacturer, vendor, wholesaler, distributor, importer, exporter, or any other type of supplier.

In some implementations, the demand sensing module performs analytics on the demand sensing data to generate one or more demand reports for the supplier IMS 162. When the user selects the “Reports” tab 602, a report 604 showing the sales and shoppers' feedback may be displayed. The report 604 may be associated with one or more products (e.g., bacon strips) supplied by the supplier to the retailer. As shown, the report 604 illustrates the number of people who likes and dislikes the product.

The supplier IMS 162 may also provide other features, including features similar to those provided by the retailer IMS 152, as previously discussed. For instance, the supplier IMS 162 may be updated with social networking data provided by the social shopping application 124. As shown, an ongoing chatter 606 between the consumer and the supplier may be displayed. The user of the supplier IMS 162 may post comments on one or more of the products. The user may also select the “Products” tab 608 to review information about the products supplied to retailers. In addition, the user may select the “Focus” tab 610 to review transactional or POS data associated with the supplied products.

Referring back to FIG. 2, at 208, the demand sensing module 122 may further send one or more recommendations to the users. The recommendations may include similar or related items. Similar items are comparable or alike (e.g., in the same category), while related items are often purchased together with the target item.

The recommendations may be generated based on the demand sensing data (e.g., user data, temporal and/or spatial data, transactional or point-of-sale (POS) data, non-transactional data, social network data, etc.). For example, when a consumer scans or adds a carton of milk into the shopping cart, the demand sensing module 122 may send a notification to the consumer device 140 via the consumer interface 142. The notification may recommend other products that are in close proximity to the shelf (or aisle) displaying milk cartons or where the consumer is currently browsing. The notification may also include recommendations of other similar or related products, such as other dairy products or breakfast items (e.g., cereal). Other demand sensing data, such as the consumer's purchasing history (e.g., category, type, brand or price range of previous purchases), may also be taken into account when determining the recommendation. For example, the recommendations may include a type or brand of item that the user previously bought. The recommendations may also include other information. For example, the recommendations may include information of new products, promotions or other marketing campaigns (e.g., lucky draw) in the store.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method of dynamic demand sensing comprising:
receiving demand sensing data from a consumer device, wherein the demand sensing data is generated while the consumer device is in-store;
storing the demand sensing data in an in-memory database for real-time processing;
retrieving the demand sensing data from the in-memory database and updating an information management system with the retrieved demand sensing data; and
generating a recommendation based on the demand sensing data.

2. A computer-implemented method of dynamic demand sensing comprising:
receiving demand sensing data from a consumer device, wherein the demand sensing data is generated while the consumer device is in-store;
updating an information management system with the demand sensing data; and
performing analytics on the demand sensing data to generate a demand report displayed at the information management system.

3. The computer-implemented method of claim 2 wherein the demand sensing data comprises user data, temporal data, spatial data, transactional data, non-transactional data, social network data, or a combination thereof.

4. The computer-implemented method of claim 3 wherein the demand sensing data comprises spatial data that identifies a physical store section where the consumer device is located.

5. The computer-implemented method of claim 4 wherein the spatial data is combined with temporal data.

6. The computer-implemented method of claim 3 wherein the demand sensing data comprises transactional data associated with a particular consumer, including the consumer's purchasing history.

7. The computer-implemented method of claim 3 wherein the demand sensing data comprises non-transactional data generated in response to a consumer scanning, using the consumer device, an image of an item or portion thereof.

8. The computer-implemented method of claim 3 wherein the demand sensing data comprises social network data received via a social shopping application.

9. The computer-implemented method of claim 8 further comprising receiving input from a consumer via a mobile application implemented in the consumer device, wherein the mobile application interacts with the social shopping application to provide the social network data.

10. The computer-implemented method of claim 9 wherein the input from the consumer comprises ratings, recommendations or comments about one or more products.

11. The computer-implemented method of claim 2 wherein the information management system comprises a retailer information management system.

12. The computer-implemented method of claim 11 wherein updating the information management system comprises tracking a location of the consumer device and displaying, at the information management system, the tracked location in a floor plan.

13. The computer-implemented method of claim 11 wherein updating the information management system comprises displaying, at the information management system, transactional data associated with an in-store consumer.

14. The computer-implemented method of claim 11 wherein updating the information management system comprises displaying, at the information management system, social networking data associated with an in-store consumer and a retailer.

15. The computer-implemented method of claim 2 wherein the information management system comprises a supplier information management system.

16. The computer-implemented method of claim 15 wherein updating the information management system comprises displaying, at the information management system, social networking data associated with an in-store consumer and a supplier.

17. The computer-implemented method of claim 2 wherein performing analytics on the demand sensing data includes summarizing consumer feedback derived from the demand sensing data.

18. The computer-implemented method of claim 2 further comprising generating a recommendation based on the demand sensing data and sending the recommendation to the consumer device.

19. A non-transitory computer-readable medium having stored thereon program code, the program code executable by a computer to:
receive demand sensing data from a consumer device, wherein the demand sensing data is generated while the consumer device is in-store;
update an information management system with the demand sensing data; and
perform analytics on the demand sensing data to generate a demand report displayed at the information management system.

20. A system comprising:
a non-transitory memory device for storing computer-readable program code; and
a processor in communication with the memory device, the processor being operative with the computer-readable program code to:
receive demand sensing data from a consumer device, wherein the demand sensing data is generated while the consumer device is in-store;
update an information management system with the demand sensing data; and
perform analytics on the demand sensing data to generate a demand report displayed at the information management system.
